(19) United States
(12) Patent Application Publication
(10) Pub. No.: US 2015/0141117 A1
(43) Pub. Date: May 21, 2015

(54) Method, System, and Device for Conducting a Wagering Game Using Playing Cards

(71) Applicant: Steven Wright, Huntington Beach, CA (US)

(72) Inventor: Steven Wright, Huntington Beach, CA (US)

(21) Appl. No.: 14/083,290

(22) Filed: Nov. 18, 2013

(51) Int. Cl. G07F 17/32

(52) U.S. Cl. CPC G07F 17/3293
USPC 463/22

(57) ABSTRACT

A base wager is received and an initial player hand and an initial dealer hand are dealt. If the initial player hand forms a target value hand, a target hand payout is issued and the game terminated, unless the initial dealer hand is also a target value hand, resulting in a push. A final player hand is formed by receiving at least one additional playing card to the initial player hand or standing. If at least one additional card is received, a determination is made whether the final player hand, which contains more than the initial quantity of playing cards, forms a player winning hand, in which case a player winning hand payout is issued and the game terminated. A final dealer hand is formed and any remaining base wagers are resolved by comparing the final player hand to the final dealer hand and the target value.

### FIELD OF THE INVENTION

The present invention relates to methods, systems, and devices for conducting wagering games. More specifically, the present invention includes methods, systems, and devices for conducting a wagering game in which a final player hand is formed by adding playing cards to a hand and a payout is issued if the combination of playing cards in the final player hand constitutes a winning player hand.

### BACKGROUND OF THE INVENTION

A game well known in the gambling industry is video poker. In the conventional game of video poker known in the art, a gaming machine with an incorporated data processor and display is provided. The gaming machine receives a player's wager thereby prompting the data processor to randomly select a hand of cards from a data storage containing data representing a deck of playing cards. The hand of cards, typically five cards, is displayed face up to represent an initial hand.

The player selects which, if any, of the five cards of the initial hand to hold and prompts the data processor, through an input device, to discard the remaining cards. The data processor replaces the discarded cards with cards selected from the data storage containing data representing a deck of cards depleted of the initial hand. The replacements along with the held cards form a final hand.

The data processor compares the final outcome to a set of pre-determined winning combinations stored in the data storage. Typically, these combinations represent the conventional ranked poker hands such as a pair of Jacks or better, two pair, three of a kind, and so forth. If the player's final outcome matches a winning combination, the player is rewarded according to a predetermined fixed pay table. Otherwise, the final outcome is deemed to be a loss and the player's wager is retained by the gaming machine.

There are many variations on conventional video poker. For example, wild cards may be designated such as in the well-known games of Deuces Wild, Jokers Wild, and the like. Other variations are directed to poker games in which a player may conduct multiple game hands. In one such example, shown in U.S. Pat. No. 5,823,873 to Moody, a player makes a separate wager for each game hand the player wishes to conduct. A first game hand is dealt face-up and the remaining game hands are displayed face-down. The player selects cards from the main game hand to be held and the cards held from the first game hand are copied into the other game hands. Independently generated replacement cards are dealt to each of the game hands. Each game hand is evaluated separately against a pay table and the decision to issue an award or retain the player's wager is made separately for each game hand.

Blackjack is another well-known card game played in casinos. The object of the game is to have a final hand total closer to twenty-one than the final dealer hand total without exceeding twenty-one. For purposes of calculating the final hand total, each card has a value equal to its face value except face cards, which have a value of ten, and Aces, which may have a value of eleven or one, depending on which forms the best hand. In conventional blackjack, the suit of the cards is irrelevant. A final hand total that exceeds twenty-one is said to “bust” and is considered a losing hand.

The form of blackjack played in casinos is banked by the house and is played between a dealer, representing the house, and at least one player. In a typical blackjack game, each player makes a base wager in a wagering area on a playing surface. The dealer deals an initial player hand containing two cards to each player and an initial dealer hand containing two cards to himself or herself. The two cards of the initial dealer hand may be dealt together, with one card face up and the other face down, or dealt separately, with a first card dealt before completing the players' hands and a second card dealt after completing the players' hands.

If the initial dealer hand does not have a natural twenty one, any initial player hand receiving a natural twenty-one or blackjack, i.e. a total of twenty-one in the initial dealt hand, is immediately rewarded, typically at a rate of 2:1, 3:2, or 6:5, and play is terminated as to that player. Each remaining player examines his or her initial player hand and decides whether to hit, i.e. receive another card, or stand, i.e. stop with the current hand. A player may hit as many times as the player wishes as long as the player does not bust, i.e. receive a card causing the cumulative sum of the values of the cards in the player's hand to exceed twenty-one. When a player busts, the player's wager is immediately collected and play is terminated as to that player.

A player may have additional options available depending on the initial player hand dealt. For example, a player may have the option to double down. Although the availability of the double down option varies from casino to casino, doubling down allows a player to double the player's wager in exchange for a single additional card dealt to the initial player hand. This option is typically selected when a player feels that he or she has a reasonable chance of winning by drawing only a single card. This is often the case when the player has an initial two-card total of ten or eleven, so that any ten-value card will give the player a total of twenty or twenty-one, or when the dealer has an exposed card of a five or six, and the player feels it likely that the dealer will bust.

A player may also have the option to split the initial player hand. Specifically, if the player receives a pair, i.e. two cards having the same card value, the player may split the pair and use each card as a basis for a separate hand. For example, if a player were to be dealt a pair of eights, the player may choose to split the pair and continue play with two separate hands each containing an eight and an additional dealt card. Each of the individual split hands is played independently, with the player free to hit or stand (or, possibly, split or double down depending on the house rules) the newly formed split hands.

After all the players have formed final hands, the dealer reveals the face-down card in the dealer hand. The dealer completes the dealer hand according to established house rules. That is, the casino uses established rules to eliminate discretion by the dealer in forming the dealer hand and the dealer hits or stands as the house rules dictate. The final dealer hand is compared to each final player hand and the target value of twenty-one to resolve the wagers. In resolving the wagers, a player hand outranks or beats a dealer hand if the total sum of the cards in the player hand is closer to twenty-one than the total sum of the cards in the dealer hand is. For example, if the final dealer hand has a total sum of nineteen and a final player hand has a total sum of twenty, the final player hand “wins” because it is closer to the target value of twenty-one than the final dealer hand is. Wagers on winning player hands are typically rewarded at even money, i.e., 1:1. Wagers are collected from player hands with a final hand total further from twenty-one than the final hand total of the dealer hand is. If the dealer hand busts, all players who did not bust or receive a blackjack are rewarded. If the player and dealer push, i.e., have hands with the same final hand total without busting, the player's wager is returned.

### SUMMARY OF THE INVENTION

A method for conducting a game is conducted using a device having a random outcome generator. In an optional embodiment, the random outcome generator is a playing card shuffler. In one such optional embodiment, a playing card shuffler includes a data processor, playing card handling apparatus in communication with the data processor, and memory in communication with the data processor. In an optional embodiment, the playing card handling apparatus receives a plurality of playing cards in an initial order and the memory stores program instructions that are executed by the data processor to control the playing card handling apparatus to reorder the plurality of playing cards from the initial order into a random order and dispense at least some of the playing cards to generate the random outcome of the random outcome generator.

In another optional embodiment, the random outcome generator is a video gaming device. In one such optional embodiment, a video gaming device may include a data processor, a display in communication with the data processor, and memory in communication with the data processor. In one such optional embodiment the memory stores electronic representations of playing cards and program instructions executable by the data processor to randomly select playing cards from the electronic representations of playing cards and display the randomly selected playing cards at the display to generate the random outcome of the random outcome generator.

Returning to the game itself, a base wager is received. An initial player hand consisting of an initial quantity of playing cards is dealt based on a random outcome generated by the random outcome generator. In an optional embodiment, the playing cards have, at least, a value associated with each playing card. In a further optional embodiment, the playing cards have a value and a suit associated with each playing card. An initial dealer hand consisting of an initial quantity of playing cards is also dealt based on a random outcome generated by the random outcome generator.

A final player hand is formed from the initial player hand by standing on the initial player hand or receiving at least one additional playing card dealt to the initial player hand. In an optional embodiment, any additional playing cards dealt are based on a random outcome generated by the random outcome generator. Optionally, the final player hand is restricted from receiving any additional playing cards when the sum of the values of the playing cards in the final player hand exceeds the target value.

A final dealer hand is formed from the initial dealer hand by standing on the initial dealer hand or receiving at least one additional playing card dealt to the initial dealer hand. Optionally, any additional playing card is dealt based on a random outcome generated by the random outcome generator. Optionally, the final dealer hand is restricted from receiving any additional playing cards when the sum of the values of the playing cards in the final dealer hand exceeds the target value.

A target value hand is defined. In an optional embodiment, a target value hand is a hand containing playing cards whose sum is equal to a target value. Also, at least one player winning hand is defined. A player winning hand is a final player hand having a quantity of playing cards greater than the initial quantity of playing cards. Thus, for example, in a game in which the initial player hand contains two playing cards, a player winning hand may include final player hands with three, four, or five playing cards. In one optional embodiment, the player winning hand comprises a final player hand containing a predetermined combination of playing cards. In such an optional embodiment, the combination of playing cards may be based on the suit(s) of the playing cards, the value(s) of the playing cards, the sum of the values of the playing cards, or any other characteristic of the playing cards whether alone or in combination. For example, in one optional embodiment, the player winning hand comprises a final player hand containing playing cards having values with a predetermined sum. In a further optional embodiment, the predetermined sum is greater than the target value.

A target hand payout based on the base wager is issued when the initial player hand is a target value hand and the initial dealer hand is not a target value hand. Optionally, the base wager is collected when the initial dealer hand is a target value hand and the initial player hand is not a target value hand. Optionally, the base wager is returned when the initial player hand and the initial dealer hand both include a target value hand.

A player winning hand payout based on the base wager is issued when the final player hand, which is formed by receiving at least one additional playing card to the initial player hand, is a player winning hand. That is, to receive a player winning hand payout, two criteria must be satisfied: (a) the final player hand was formed by receiving at least one additional playing card to the initial player hand and (b) the final player hand is a player winning hand. In an optional embodiment, the player winning hand payout is issued regardless of the final dealer hand. Thus, in one optional embodiment, the player winning hand payout is issued even if the final dealer hand is a target value hand insofar as the player winning hand(s) outrank all other hands.

If the initial dealer hand is not a target value hand and neither the initial player hand is a target value hand nor the final player hand is a player winning hand, the sum of the values of the playing cards in the final player hand is compared to the sum of the values of the playing cards in the final dealer hand and the target value and the base wager is resolved based on the comparison.

### BRIEF DESCRIPTION OF THE DRAWINGS

FIG. 1 is a flowchart of a method according to an embodiment of the present invention;

FIG. 2 is a flowchart of a method according to an embodiment of the present invention;

FIG. 3 is a block diagram of a device according to an embodiment of the present invention;

FIG. 4 is a block diagram of a device according to an embodiment of the present invention.

### DESCRIPTION

Reference is now made to the figures wherein like parts are referred to by like numerals throughout.

The present invention includes methods and devices for conducting blackjack-type games. Specifically, the present invention includes embodiments of methods and devices for conducting games based on the familiar conduct of blackjack with modifications to the pay structure and hand formation process.

The present invention may be implemented in a live table game, electronic device, or hybrid live and electronic system. For example, the present invention could be implemented at: live tables; electronic tables; electronic gaming machines; linked gaming terminal systems; or networked or standalone personal computers, mobile phones, mobile devices, interactive televisions, kiosks, or the like. It is noted that these examples are intended to be illustrative rather than exhaustive.

For example, in one optional embodiment, the present invention includes a method. The method may be conducted at a live table using a live dealer/banker/player-banker, at an electronic table using a live dealer/banker/player-banker, at an electronic device, or any combination thereof. In an optional embodiment conducted at a live or electronic table, the playing cards and/or gaming chips may be physical or electronic in form.

It is noted that the description below uses the phrases “initial dealer hand,” “final dealer hand,” and “dealer hand.” These phrases should not be interpreted as limiting. That is, in using these phrases, it is contemplated that the initial dealer hand, final dealer hand, and/or dealer hand may be conducted by a house dealer, house banker, player-banker, player, or the like, either as a live person or via a computer executing program instructions (or a combination thereof).

A method and device according to the present invention may be conducted using a single deck or multiple decks of playing cards, or electronic representations thereof. Moreover, the present invention may utilize conventional fifty-two card decks, extended decks (such as decks supplemented with Jokers, or the like), truncated decks (such as Spanish decks or the like), or any other deck constitution. In an optional embodiment implemented on a device, the constitution of the deck(s) may be a game parameter stored in memory.

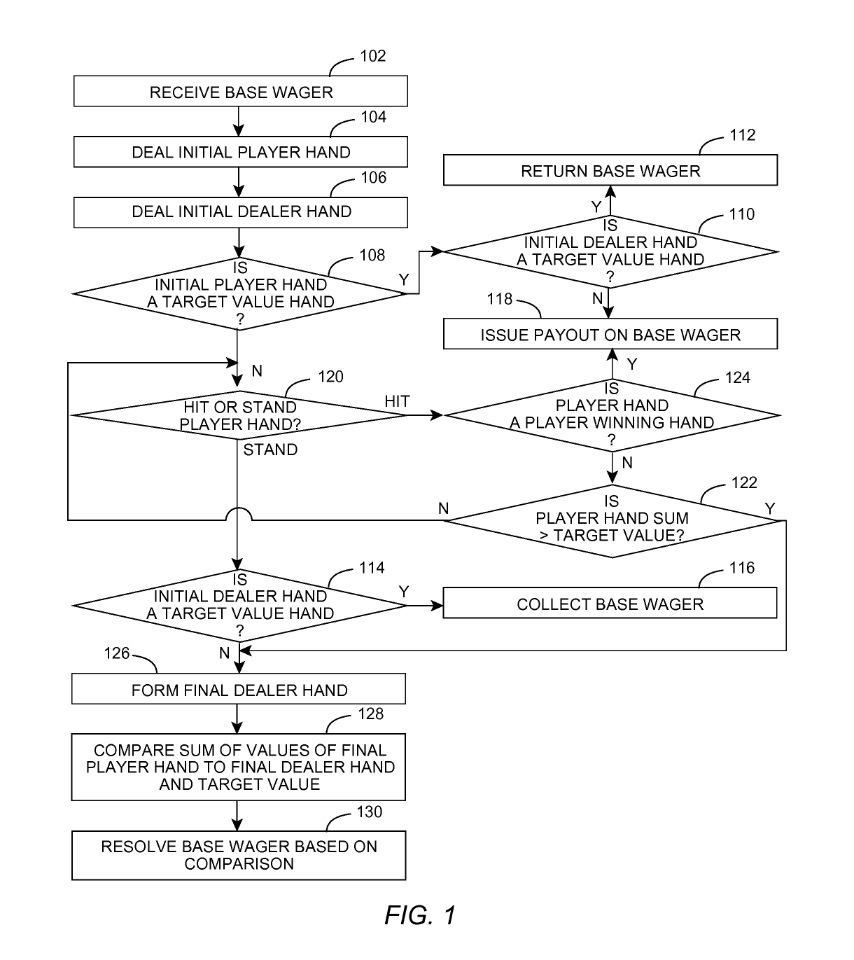

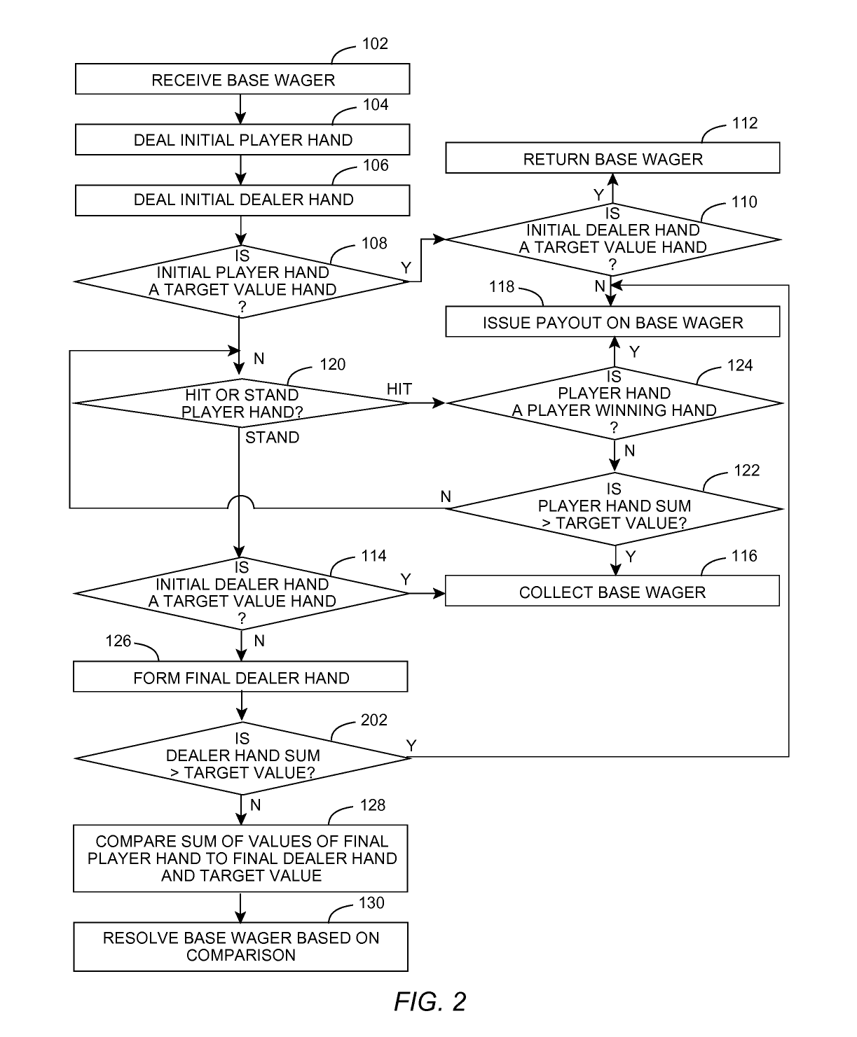

Referring to FIGS. 1 and 2, in one optional embodiment, a method includes defining at least one player winning hand and at least one target value hand. In an optional embodiment, a target value hand is a hand (either a player hand or a dealer hand) in which the sum of the values of the playing cards in the hand equals a predetermined target value. For example, in one optional embodiment, a target value is twenty-one (or some variation thereon, such as 21½). Thus, in one such example, a target value hand may be formed from a two-card hand containing a ten-value playing card plus an ace valued as eleven. In a variation thereon, a target value hand may be formed from a two-card hand containing a ten-value playing card plus an ace valued as 11½ when included in a two-card hand, or, alternatively, an ace, which is valued at eleven, plus a playing card valued at 10½ when included in a two-card hand.

In an optional embodiment, a player winning hand may require multiple criteria to be satisfied. In one such example, a player winning hand may be required to: (a) include a predetermined combination of playing cards and (b) be formed by receiving at least one additional playing card after being dealt an initial player hand. Referring first to the constitution of the player hand, a player winning hand may include a predetermined poker combination, pai gow combination, baccarat combination, blackjack combination, or the like. Referring to the formation of the hand, as discussed below, an initial player hand includes an initial quantity of playing cards. In such an optional embodiment, a player winning hand must include a quantity of playing cards that is greater than the initial quantity of playing cards. For example, in an optional embodiment, an initial player hand includes two playing cards and a winning player hand includes three or more playing cards.

Stated more concretely, in one example, the initial player hand includes two playing cards. In such an optional embodiment, examples of winning player hands may include: three of a kind; four of a kind; five of a kind; three-, four-, or five-card straight; three-, four-, or five-card flush; three-, four-, or five-card straight flush; or the like. It is contemplated that player winning hands could include general holdings (such as any three of a kind) or specific holdings (such as 8 8 8, but not necessarily other three of a kind hands).

In an optional embodiment, a pay table may define payouts associated with player winning hands. As noted in greater detail below, the pay table applies to the base wager in the blackjack game rather than a side wager or secondary wager. Thus, the pay table in such an optional embodiment changes the payouts in the base game itself as distinguished from creating a separately wagered side game or proposition wager. In an optional embodiment, player winning hands are rewarded at greater than even money. In a further optional embodiment, at least some of the payouts for player winning hands are paid at greater than the payout for a target value hand. For example, if a game includes a payout for target value hands of three to two, at least one of the payouts for player winning hands is greater than three to two. The pay table correlates player winning hands to payouts for those player winning hands. Examples below illustrate pay tables with player winning hands and associated payouts. However, these pay tables should be understood to be illustrative rather than limiting since the player winning hands and/or payouts could vary in alternate optional embodiments. For example, a pay table may vary depending on the desired house edge, the frequency of player winning hands, and the payout for target value hands. Tables 1-3 illustrate example pay tables for modified player winning hands.

TABLE 1

| Player Winning Hand | Payout |
|---|---|
| 8 8 8 (matching suit) | 5 to 1 |
| 8 8 8 (matching color) | 3 to 1 |
| 8 8 8 (mixed suit/color) | 1 to 1 |

TABLE 2

| Player Winning Hand | Payout |
|---|---|
| Five of a Kind | 20 to 1 |
| Four of a Kind | 10 to 1 |
| 8 8 8 | 5 to 1 |
| Three of a Kind (other than 8s) | 1 to 1 |

TABLE 3

| Player Winning Hand | Payout |
|---|---|
| Five of a Kind | 25 to 1 |
| Five-Card Straight Flush | 20 to 1 |
| Five-Card Straight or Five-Card Flush | 15 to 1 |
| Four of a Kind | 10 to 1 |
| Four-Card Straight Flush | 5 to 1 |
| Four-Card Straight or Four-Card Flush | 4 to 1 |
| Three of a Kind | 3 to 1 |
| Three-Card Straight Flush | 2 to 1 |
| Three-Card Straight or Three-Card Flush | 1 to 1 |

Returning to FIGS. 1 and 2, a base wager is received 102. As noted above, depending on the optional embodiment, the base wager may be designated using physical gaming chips or electronic representations of gaming chips. In an optional embodiment, the base wager may be subject to table limits. In an optional embodiment, a table fee may be assessed in place of, or in addition to, a base wager.

An initial player hand is dealt 104. An initial player hand includes an initial quantity of playing cards. In one optional embodiment, the initial player hand includes two playing cards. An initial dealer hand is also dealt 106. Although FIGS. 1 and 2 illustrate that an initial dealer hand is dealt along with the initial player hand, it is contemplated that, in alternate optional embodiments, the initial dealer hand may be dealt at a different time from the initial player hand and/or may be dealt in stages (e.g., one playing card dealt when the initial player hand is dealt, and additional playing cards dealt at a later time). In the optional embodiment illustrated in FIGS. 1 and 2, the initial dealer hand contains the same quantity of playing cards as the initial player hand, although in alternate optional embodiments, the initial dealer hand and initial player hand may contain different quantities of playing cards. More specifically, in one optional embodiment, the initial player hand and the initial dealer hand each include two playing cards, with one of the playing cards of the initial dealer hand dealt face-up.

In one optional embodiment, a determination 108 is made whether the initial player hand is a target value hand. In one such optional embodiment, the determination is made by comparing the initial player hand to the predetermined target value hand(s). When the initial player hand is a target value hand, a target hand payout may be issued 118 and play of that player hand is terminated, so long as the initial dealer hand is not determined 110 to be a target value hand. If both the initial player hand and initial dealer hand are determined to be target value hands, the base wager is pushed, i.e., returned 112 and play of that player hand is terminated.

Thus, in one example, a target value hand is a hand in which the sum of the values of the playing cards in the hand equals a predefined target value. As discussed above, a predefined target value may be any number, such as 21, 21½, or the like. In one example, when the initial player hand contains two playing cards having values that have a sum of 21, the initial player hand is a target value hand. As illustrated in FIGS. 1 and 2, a target hand payout would be issued unless the initial dealer hand also contains two playing cards that have a sum of 21. When both the initial player hand and initial dealer hand are target value hands, the base wager pushes, i.e., is returned.

If a determination is made that the initial player hand is not a target value hand, a determination 114 may be made whether the initial dealer hand is a target value hand. In the event that the initial player hand is not a target value hand, but the initial dealer hand is a target value hand, the base wager may be collected 116 and play may be terminated.

A final player hand is formed by electing 120 to hit (receive additional playing cards) or stand (cease receiving additional playing cards) on the player hand. In forming the final player hand, the target value may be used solely to determine the quantity of playing cards in the final player hand and final dealer hand. That is, unlike Blackjack or Twenty-One, the primary goal of the present method is for the player to form a player winning hand. If the player is unable to form a player winning hand, the player's secondary goal is to form a final player hand that outranks the final dealer hand. In this regard, the target value is used to determine how many playing cards can be added to the player hand to form the final player hand. That is, as discussed in greater detail below, additional playing cards may be added to a player hand until the sum of the values of the playing cards in the player hand is determined 122 to be greater than, or equal to, the target value.

In one example, illustrated in FIG. 1, the final player hand is automatically formed once the sum of the values of the playing cards in the player hand is greater than, or equal to, the target value. Thus, if the target value is 21½ and an initial player hand includes the playing cards 8⋄ 8 [symbol] and the playing card 8 [symbol] is dealt when the initial player hand is hit, the final player hand may be 8⋄ 8 [symbol] 8 [symbol] . In this example, the sum of the values of the playing cards in the player hand is twenty-four, which is greater than the target value, so the method may require the player to stand on the final player hand of 8⋄8 [symbol] 8 [symbol] .

In another example, illustrated in FIG. 2, the base wager is collected 116, and the game is terminated, when the sum of the values of the playing cards in the player hand is determined 122 greater than the target value. Thus, if the target value is 21½ and an initial player hand includes the playing cards 7 [symbol] 8 [symbol] and the playing card K⋄ is dealt when the initial player hand is hit, the hand has busted and the base wager is collected. Conversely, if the hit card had been 6 [symbol] , the final player hand would consist of 6 [symbol] 7 [symbol] 8 [symbol] , which may constitute a player winning hand, e.g., a three-card straight flush.

In a further optional embodiment, the final player hand may be formed according to predetermined draw rules. For example, in an optional embodiment, additional playing cards may not be added to a player hand in which the sum of the values of the playing cards already in the player hand meets or exceeds a minimum player value. Thus, in one such example, in which the target value is 21½, the minimum player value may be a “hard” eighteen, i.e., a player hand in which the sum of the values of the playing cards is equal to eighteen with aces counted as one. In such an example, no additional playing cards may be dealt to a hand with a “hard” eighteen or greater.

While not illustrated in FIGS. 1 and 2, it is contemplated that the present method could include options to, for example, split pairs to attempt to form two final player hands, double down to receive one, and only one, additional playing card to form a final player hand, surrender to receive at least a portion of the base wager in exchange for not forming a final player hand, or the like. In such optional embodiments, splitting, doubling down, surrendering, or the like may be conducted in a manner consistent with conventional Blackjack or Twenty-One. Additionally, it is contemplated that prior to forming a final player hand, insurance may be offered if the playing card dealt face-up to the initial dealer hand is a predetermined value, e.g., an ace. Again, insurance in such an optional embodiment may be conducted substantially consistent with conventional Blackjack or Twenty-One.

In the optional embodiment of FIGS. 1 and 2, once the final player hand is formed, either due to the player electing to stand or the player being required to stand due to the sum of the values of the playing cards in the player hand equaling or exceeding the target value, a determination 124 is made whether the final player hand is a player winning hand. As noted above, the player winning hand(s) may be defined so that at least one additional playing card must be added to the initial player hand to form a player winning hand. Thus, as illustrated in FIGS. 1 and 2, a player winning hand is only possible if an election is received to hit the initial player hand with at least one additional playing card.

When a player winning hand is formed according to the optional embodiments of FIGS. 1 and 2, a player winning hand payout is issued 118 regardless of the dealer hand and play of that player hand is terminated. In such an optional embodiment, a player winning hand outranks all final dealer hands. Thus, in the optional embodiments illustrated in FIGS. 1 and 2, a player winning hand payout is issued 118 without even forming the final dealer hand, although it is contemplated that the player winning hand payout may be issued after the final dealer hand and all final player hands are formed.

In an alternate optional embodiment, the final dealer hand is taken into account in determining whether to issue a player winning hand payout. For example, in one such optional embodiment, the player winning hand payout may be paid, and play may be terminated, when the final player hand is a player winning hand, and the final dealer hand exceeds the target value. In such an example, the player winning hand payout is not issued, and the base wager may be collected, if the final dealer hand is less than, or equal to, the target value.

In yet another optional embodiment, the final dealer hand may also be eligible to form “winning hands” similar to those in the final player hand. In one such optional embodiment, a player winning hand payout may be paid, and play may be terminated, when the final player hand has a higher ranking winning hand than the final dealer hand has. In such an example, the player winning hand payout is not issued, and the base wager may be collected, if the final dealer hand has a higher ranking “winning hand.” Optionally, the base wager may be returned if the final dealer hand and final player hand have “winning hands” of equal rank.

A final dealer hand is also formed 126. In an optional embodiment, a final dealer hand may be formed according to house rules for hitting or standing that are similar or identical to house rules commonly found in conventional Blackjack or Twenty-One. For example, a typical house rule would be that the dealer hits a hand until the total sum of the cards in the final dealer hand is seventeen or greater with aces counted as one, or eighteen or greater with aces counted as eleven. In another example, a typical house rule would be that the dealer hits a hand until the total sum of the cards in the final dealer hand is seventeen or greater, with any aces counted as eleven, unless counting the ace as eleven causes the total sum to exceed twenty-one.

In one optional embodiment illustrated in FIG. 2, if, in the course of forming a final dealer hand, the total sum of the cards in the dealer hand exceeds 202 the target value, a dealer bust occurs and the base wager may be rewarded 118. If the final dealer hand does not exceed the target value, the base wager is resolved 130 based on a comparison 128 of the sum of the values of the playing cards in the final player hand to the sum of the values of the playing cards in the final dealer hand and the target value.

In the alternate optional embodiment of FIG. 1, neither the player hand nor the dealer hand can bust. In the optional embodiment of FIG. 1, the base wager is always resolved based on a comparison 128 of the sum of the values of the playing cards in the final player hand to the sum of the values of the playing cards in the final dealer hand and the target value, unless the player hand contained a player winning hand or the player hand or dealer hand contained a target value hand.

For example, in one such optional embodiment, the base wager may be resolved by comparing the final player hand to the final dealer hand compared 128 to the final player hand and the target value of twenty-one and base wagers resolved 130 based on the relative differences between the final dealer hand and final player hand and the target value as in conventional blackjack.

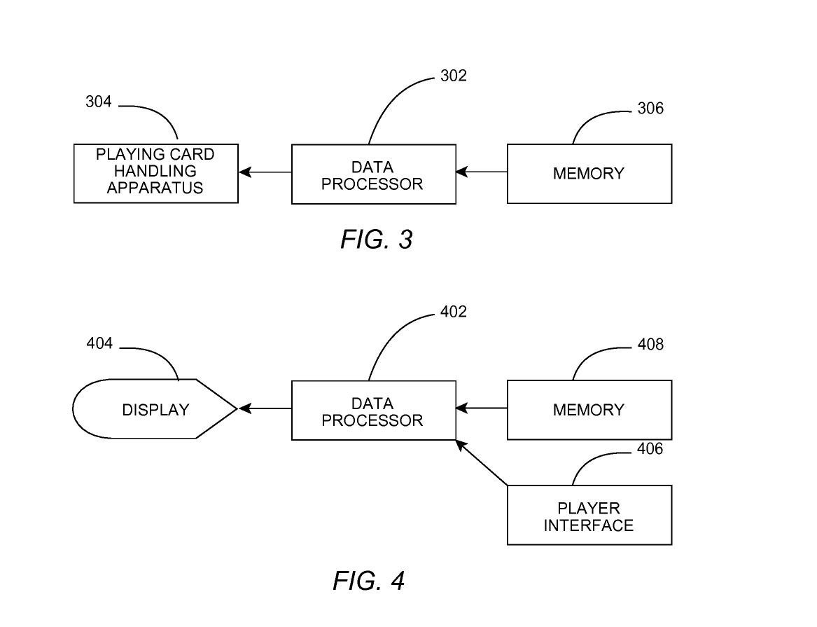

As illustrated in FIGS. 3 and 4, a method according to an embodiment of the present invention may be implemented using a device. In one optional embodiment, the device only serves to produce random outcomes. Such a random outcome generator may take the form of a playing card shuffler incorporating a random number generator that randomizes playing cards and, optionally, deals randomized hands. For example, in one such optional embodiment, a playing card handing apparatus may be controlled by a data processor 302. Physical playing cards may be loaded into the playing card handling apparatus 304 in an initial order. The data processor 302 may execute program instructions stored at a memory 306 to control the playing card handing apparatus to reorder the physical playing cards into a new, random order. It is contemplated that playing card handling apparatus 304 may take many different forms, and may reorder the physical playing cards in any manner. For example, conventional playing card shufflers may include a playing card handling apparatus in the form of a rotary or linear cartridge that randomly stacks playing cards, thereby taking an unshuffled stack of playing cards and forming a shuffled stack.

Alternatively, a device may perform additional tasks aside from producing random outcomes, such as displaying hands, evaluating and comparing hands, receiving input, and the like. For example, in one such optional embodiment, a device includes a data processor 402 in communication with a display 404, a player interface 406, and a memory 408. A base wager is received or designated through a player interface 406. Such a player interface may take any form, including a button panel, keyboard, keypad, or the like. In a further optional embodiment, the player interface 406 and display 404 may be combined into a touchscreen device. In response to the base wager, a random outcome is generated by a random outcome generator. In one such optional embodiment, the random outcome generator is a software, firmware, or hardware random number generator working in concert with a data processor 402 that maps random numbers generated by the random number generator to outcomes, such as playing cards or playing card combinations.

An initial player hand is selected by the random outcome generator and displayed at the display 404. Optionally, a partial initial dealer hand is likewise selected by the random number generator and displayed at the display 404. It is contemplated that the device may be configured for multiple players with each player having his or her own display 404. Alternatively, the device may be configured for multiple players sharing a display 404. In yet another optional embodiment, the device may be configured for a single player and a single display 404. It is also contemplated that a dealer hand may be displayed at a separate display or on the same display as the player hand(s).

In one optional embodiment, a data processor 402 may determine whether the initial player hand is a target value hand, as determined by parameters stored at a memory 408. If so, a determination may be made by the data processor 402 whether the initial dealer hand is a target value hand. Based on the determination, the base wager may be resolved by issuing a target hand payout (if only the initial player hand is a target value hand) or pushing, i.e., returning, the base wager (if both the initial player hand and initial dealer hand are target value hands). In the event that the initial player hand is a target value hand, play may be terminated after resolution of the base wager.

A final player hand is formed substantially as described above, with elections to hit or stand (and, optionally, split and double down) received through the player interface 406. In an optional embodiment, a data processor 402 evaluates the final player hand to determine if it matches a player winning hand as stored in parameters at a memory 408. If so, the base wager may be resolved by paying an award based on a pay table stored at a memory device 408 and play may be terminated. As discussed above, the award may be contingent on a comparison of the final player hand with the final dealer hand or, alternatively, may occur instantly independent of the final dealer hand.

A final dealer hand is formed by the data processor 402. If neither the final player hand nor the final dealer hand form a target value hand, and the final player hand is not a player winning hand, the final player hand is compared to the final dealer hand and the target value of twenty-one by a data processor 402. If the final player hand is closer to the target value than the final dealer hand is, an award is issued by the data processor based on the base wager.

While certain embodiments of the present invention have been shown and described it is to be understood that the present invention is subject to many modifications and changes without departing from the spirit and scope of the claims presented herein.

1. A method for conducting a game using a device having a random outcome generator utilizing playing cards having, at least, a value associated with each playing card, said game including receiving a base wager, dealing an initial player hand consisting of an initial quantity of playing cards based on a random outcome generated by said random outcome generator, dealing an initial dealer hand consisting of an initial quantity of playing cards based on a random outcome generated by said random outcome generator, forming a final player hand from said initial player hand by standing on said initial player hand or receiving at least one additional playing card dealt to said initial player hand wherein said at least one additional playing card is dealt based on a random outcome generated by said random outcome generator, and forming a final dealer hand from said initial dealer hand by standing on said initial dealer hand or receiving at least one additional playing card dealt to said initial dealer hand wherein said at least one additional playing card is dealt based on a random outcome generated by said random outcome generator, the method comprising:
defining a target value hand to be a hand containing playing cards whose sum is equal to a target value;
defining at least one player winning hand to be a predetermined final player hand having a quantity of playing cards greater than said initial quantity of playing cards;
issuing a target hand payout based on said base wager when said initial player hand is a target value hand and said initial dealer hand is not a target value hand;
returning said base wager when said initial player hand and said initial dealer hand both include a target value hand;
issuing a player winning hand payout based on said base wager when said final player hand is formed by receiving at least one additional playing card to the initial player hand and said final player hand is a player winning hand, wherein said player winning hand payout is issued regardless of the final dealer hand;
comparing the sum of the values of the playing cards in said final player hand to the sum of the values of the playing cards in said final dealer hand and said target value if said initial dealer hand is not a target value hand and neither said initial player hand is a target value hand nor said final player hand is a player winning hand; and
resolving said base wager based on said comparison.

2. The method of claim 1 wherein said random outcome generator is a playing card shuffler comprising:
a data processor;
playing card handling apparatus in communication with said data processor configured to receive a plurality of playing cards in an initial order; and
memory in communication with said data processor configured to store program instructions executable by said data processor to control said playing card handling apparatus to reorder said plurality of playing cards from said initial order and dispense at least some of said playing cards to generate said random outcome of said random outcome generator.

3. The method of claim 1 wherein said random outcome generator is a video gaming device comprising:
a data processor;
a display in communication with said data processor; and
memory in communication with said data processor configured to store electronic representations of playing cards and program instructions executable by said data processor to randomly select playing cards from said electronic representations of playing cards and display said randomly selected playing cards at said display to generate said random outcome of said random outcome generator.

4. The method of claim 1 wherein said player winning hand comprises a final player hand containing a predetermined combination of playing cards.

5. The method of claim 1 wherein said player winning hand comprises a final player hand containing playing cards having values with a predetermined sum.

6. The method of claim 5 wherein said predetermined sum is greater than said target value.

7. The method of claim 1 wherein said final player hand is restricted from receiving any additional playing cards when the sum of the values of the playing cards in said final player hand exceeds said target value.

8. A method for conducting a game using a device having a random outcome generator utilizing playing cards having, at least, a value associated with each playing card, said game including receiving a base wager, dealing an initial player hand consisting of an initial quantity of playing cards based on a random outcome generated by said random outcome generator, dealing an initial dealer hand consisting of an initial quantity of playing cards based on a random outcome generated by said random outcome generator, forming a final player hand from said initial player hand by standing on said initial player hand or receiving at least one additional playing card dealt to said initial player hand wherein said at least one additional playing card is dealt based on a random outcome generated by said random outcome generator, and forming a final dealer hand from said initial dealer hand by standing on said initial dealer hand or receiving at least one additional playing card dealt to said initial dealer hand wherein said at least one additional playing card is dealt based on a random outcome generated by said random outcome generator, the method comprising:
defining a target value hand to be a hand containing playing cards whose sum is equal to a target value;
defining at least one player winning hand to be a predetermined final player hand having a quantity of playing cards greater than said initial quantity of playing cards;
collecting said base wager when said initial dealer hand is a target value hand and said initial player hand is not a target value hand;
issuing a target hand payout based on said base wager when said initial player hand is a target value hand and said initial dealer hand is not a target value hand;
returning said base wager when said initial player hand and said initial dealer hand both include a target value hand;
issuing a player winning hand payout based on said base wager when said final player hand is formed by receiving at least one additional playing card to the initial player hand and said final player hand is a player winning hand, wherein said player winning hand payout is issued regardless of the final dealer hand;
comparing the sum of the values of the playing cards in said final player hand to the sum of the values of the playing cards in said final dealer hand and said target value if said initial dealer hand is not a target value hand and neither said initial player hand is a target value hand nor said final player hand is a player winning hand; and
resolving said base wager based on said comparison.

9. The method of claim 8 wherein said random outcome generator is a playing card shuffler comprising:
a data processor;
playing card handling apparatus in communication with said data processor configured to receive a plurality of playing cards in an initial order; and
memory in communication with said data processor configured to store program instructions executable by said data processor to control said playing card handling apparatus to reorder said plurality of playing cards from said initial order and dispense at least some of said playing cards to generate said random outcome of said random outcome generator.

10. The method of claim 8 wherein said random outcome generator is a video gaming device comprising:
a data processor;
a display in communication with said data processor; and
memory in communication with said data processor configured to store electronic representations of playing cards and program instructions executable by said data processor to randomly select playing cards from said electronic representations of playing cards and display said randomly selected playing cards at said display to generate said random outcome of said random outcome generator.

11. The method of claim 8 wherein said player winning hand comprises a final player hand containing a predetermined combination of playing cards.

12. The method of claim 8 wherein said player winning hand comprises a final player hand containing playing cards having values with a predetermined sum.

13. The method of claim 12 wherein said predetermined sum is greater than said target value.

14. The method of claim 8 wherein said final player hand is restricted from receiving any additional playing cards when the sum of the values of the playing cards in said final player hand exceeds said target value.

15. A device for conducting a game comprising:
a data processor;
a display in communication with said data processor; and
a memory in communication with said data processor configured to store electronic representations of playing cards having, at least, a value associated with each playing card, at least one target value hand comprising a hand containing playing cards whose sum is equal to a target value, at least one player winning hand comprising a final player hand having a quantity of playing cards greater than an initial quantity of playing cards, and instructions executable by said data processor to conduct the steps of:
receiving a base wager at said data processor;
dealing an initial player hand consisting of said initial quantity of playing cards based on a random outcome generated by said data processor and displaying said initial player hand at said display;
dealing an initial dealer hand consisting of said initial quantity of playing cards based on a random outcome generated by said data processor and displaying said initial dealer hand at said display;
issuing a target hand payout based on said base wager when said initial player hand is a target value hand and said initial dealer hand is not a target value hand;
returning said base wager when said initial player hand and said initial dealer hand both include a target value hand;
forming a final player hand from said initial player hand by standing on said initial player hand or receiving at least one additional playing card dealt to said initial player hand, wherein said at least one additional playing card is dealt based on a random outcome generated by said data processor;
forming a final dealer hand from said initial dealer hand by standing on said initial dealer hand or receiving at least one additional playing card dealt to said initial dealer hand wherein said at least one additional playing card is dealt based on a random outcome generated by said data processor;
issuing a player winning hand payout based on said base wager when said final player hand is formed by receiving at least one additional playing card to the initial player hand and said final player hand is a player winning hand, wherein said player winning hand payout is issued regardless of the final dealer hand;
comparing the sum of the values of the playing cards in said final player hand to the sum of the values of the playing cards in said final dealer hand and said target value if said initial dealer hand is not a target value hand and neither said initial player hand is a target value hand nor said final player hand is a player winning hand; and
resolving said base wager based on said comparison.

16. The device of claim 15 wherein said player winning hand comprises a final player hand containing a predetermined combination of playing cards.

17. The device of claim 16 wherein said player winning hand includes playing cards having a predetermined combination of one or more values.

18. The device of claim 16 wherein said playing cards each include a suit and said player winning hand includes playing cards having a predetermined combination of one or more suits.

19. The device of claim 15 wherein said player winning hand comprises a final player hand containing playing cards having values with a predetermined sum.

20. The device of claim 19 wherein said predetermined sum is greater than said target value.
